(19) United States
(12) Patent Application Publication
(10) Pub. No.: US 2014/0254222 A1
(43) Pub. Date: Sep. 11, 2014

(54) METHOD FOR OPERATING A DRIVE CONTROL FACILITY AND DRIVE CONTROL FACILITY OPERATING ACCORDING TO SAID METHOD

(71) Applicant: Siemens Aktiengesellschaft, Munchen (DE)

(72) Inventor: Klaus Nieberlein, Nurnberg (DE)

(73) Assignee: Siemens Aktiengesellschaft, Munchen (DE)

(21) Appl. No.: 14/196,400

(22) Filed: Mar. 4, 2014

(30) Foreign Application Priority Data
Mar. 5, 2013 (EP) 13157800.7

(51) Int. Cl. H02M 7/48

(52) U.S. Cl. CPC H02M 7/48
USPC 363/123

(57) ABSTRACT

A method is disclosed for the regenerative operation of a drive control facility, which includes an inverter with semiconductor switches controllable by control signals. A control logic for each control signal determines a control signal time instant and each of the semiconductor switches is controlled by a corresponding control signal generated by the control logic at the respective control signal time instant. Individual semiconductor switches are controlled prior to the determined control signal time instant by a corresponding control signal having a predetermined pre-ignition angle.

### CROSS-REFERENCES TO RELATED APPLICATIONS

This application claims the priority of European Patent Application, Serial No. 13157800.7, filed Mar. 5, 2013, pursuant to 35 U.S.C. 119(a)-(d), the content of which is incorporated herein by reference in its entirety as when fully set forth herein.

### BACKGROUND OF THE INVENTION

The present invention relates to a method for operating a drive control facility and a drive control facility operating according to the method, as well as to a computer program for implementing the method and accordingly also to a drive control facility having means for executing the computer program. The invention relates most particularly to a method for operating a drive control facility with an inverter having semiconductor switches that can be controlled with control signals.

The following discussion of related art is provided to assist the reader in understanding the advantages of the invention, and is not to be construed as an admission that this related art is prior art to this invention.

Drive control facilities of the aforesaid type are known per se. An inverter, load-side inverter, in such a drive control facility generates an output voltage with a variable frequency and voltage by virtue of the control using control signals for instance. By this means it is possible to adjust and regulate the rotational speed and the torque of e.g. an electric motor as the load of the drive control facility. During generator operation of an electric motor, the current to be fed back is provided in accordance with the grid frequency using a grid-side inverter. This also takes place by controlling the grid-side inverter with suitable control signals (basic frequency operation) based on the respective grid frequency.

During the commutation of such drive control facilities, namely the grid-side inverter operating with a basic frequency, generator operation in conjunction with a termination of the commutation results in a significant voltage drop at the phase which no longer conveys the current. The current, which is applied to the grid inductance, discharges the grid-side capacitor of the corresponding phase, which, in accordance with conventional terminology, is also referred to below as F3E capacitor (F3E or F³E=Fundamental Frequency Front End=grid-side inverter operated at basic frequency). The discharge process of the relevant F3E capacitor lasts until the current applied to the grid inductance of the corresponding phase has decayed.

Such a voltage drop is however only permissible up to a maximum value and an oscillating system is produced with the grid inductance and the capacitance of the connected load or loads, which is made to oscillate by the voltage drop. When the voltage drop is very large, oscillations can be caused which, in the case of F3E circuits, even result in faulty commutation.

Attempts have previously been made to prevent this problem by significantly increasing the capacitance of the F3E capacitors. By increasing their capacitance, it is possible to reduce the voltage drops to such a degree that the oscillation caused by the commutation is attenuated. The reduction which can thus be achieved in the oscillation produced in conjunction with the commutation results in no additional faulty commutation occurring and the voltage drop remaining within predetermined limit values.

Nevertheless, both an increase in the reactive current component resulting during operation and also an increase in the spatial requirement of such a drive control facility including F3E capacitors is associated with the increase in the capacitance of the F3E capacitors.

An object of the invention consists accordingly in specifying a further method for operating a drive control facility and a drive control facility operating according to said method. A special object of the invention further consists in specifying such a method and apparatus operating in accordance with the method, which prevents the above-described disadvantage/s and accordingly results in no or only a manageable tendency towards oscillation with comparatively small F3E capacitors.

It would therefore be desirable and advantageous to obviate prior art shortcomings and to provide an improved method for operating a drive control facility and a drive control facility operating according to the method, which prevents the above-described disadvantage/s and accordingly results in no or only a manageable tendency towards oscillation with comparatively small F3E capacitors.

### SUMMARY OF THE INVENTION

According to one aspect of the present invention, a method for the regenerative operation of a drive control facility having an inverter with semiconductor switches controllable by control signals includes determining with a control logic a control signal time instant for each control signal, and controlling individual semiconductor switches with a corresponding control signal generated by the control logic at a respective control signal time instant. The individual semiconductor switches are controlled by the corresponding control signal in accordance with a predetermined pre-ignition angle prior to the determined control signal time instant.

Control signal time instants are understood here to mean activation time instants of the semiconductor switches of the inverter (in the case of a drive control facility with only one inverter, namely a grid-side inverter) or the grid-side inverter (in the case of a drive control facility having at least a first and a second inverter, namely a grid-side inverter and a load-side inverter). The control signals for the individual semiconductor switches are generated at the control signal time instants, which in turn bring about the activation of the relevant semiconductor switch. The control signal time instants are based here on the respective grid frequency for the feedback of current generated by the connected load during generator operation.

The invention is based on the knowledge that the control of a semiconductor switch. which is brought forward and results on account of a pre-ignition angle of greater than zero, and is referred to below as pre-ignition produces a short-circuit of the semiconductor bridge with the semiconductor switch ignited prematurely (compared with the control signal time instant based on the grid frequency). On account of this pre-ignition, a brief time window develops, which ends with the normal commutation, in other words the deactivation of the semiconductor switch which was previously active in this semiconductor bridge. During this time window, a current is applied on account of the voltage drop at the active phase, so that the current can commutate from the active conducting phase to the new (corresponding to the pre-ignition even before the normal instant of commutation, active) phase. Ideally the total current even disappears at the switch-off point of the commutated phase from the current discharging via the grid inductance of the respective phase and the current flowing in via the prematurely ignited phase. In this case, the voltage drop to the new phase, in other words the phase whose semiconductor switch was ignited earlier according to the respective pre-ignition angle, would be prevented entirely at the switch-off point of the commutated phase.

With the invention, the voltage drop observed upon termination of a commutation can now advantageously be significantly reduced or even prevented at the relevant phase, on account of a suitable, in particular continuous automatic selection of a respective pre-ignition angle, without having to increase the capacitance of the F3E capacitors.

With the control signal generated according to the pre-ignition angle, the semiconductor switch associated with the next phase to be commutated is controlled such that a short-circuit of the relevant semiconductor bridge is produced at least briefly, namely during a time span according to the pre-ignition angle and thus a further active current path is still produced in addition to the semiconductor switch deactivated on account of the commutation due to the pre-ignition of the further semiconductor switch in the same semiconductor bridge.

When the pre-ignition angle is dependent on a current fed back into the respective network or on a respective grid inductance, the pre-ignition angle can advantageously be adjusted specifically to the respective operating state of the drive control facility.

When the pre-ignition angle is dependent on a voltage drop at a respective down-commutated phase in each instance, the pre-ignition angle can also be specifically adjusted to the operating state of the drive control facility which is characterized by the voltage drop at the respective down-commutated phase. The actual tendency to oscillate (not known in advance) is dependent on the grid impedance and on the likewise unknown capacitance of the connected load or further connected loads. The measurement of the voltage drop is thus the comparatively easily obtainable variable which provides details about the extent of the tendency to oscillate, and can thus be used as guidance for determining the pre-ignition angle.

The pre-ignition angle can advantageously be adjusted to the voltage drop at a respective down-commutated phase by measuring the voltage drop at the respectively down-commutated phase and the pre-ignition angle resulting from a measured value in this regard. The measured value is then linked to a resulting pre-ignition angle, for instance by a relation implemented with an amplifier circuit or suchlike between the measured value and resulting pre-ignition angle or in the form of a so-called look-up table (LUT) or in the form of a mathematical association implemented in software and included by a computer program executed by the drive control facility during operation.

According to an advantageous feature of the present invention, a voltage drop may be measured at a respectively down-commutated phase, with the pre-ignition angle then being a function of the current fed back into the power grid and the respective voltage drop. A dependency on at least one further variable expressing the operating state of the drive control facility then results when the pre-ignition angle is controlled. This dependency and thus the automatic generation of the pre-ignition angle can also be expressed with an analog circuit, a LUT or software-based formulation of a mathematical association between the respectively considered influence variables and the resulting ignition angle.

A particularly preferred embodiment of the method consists in the pre-ignition angle being a result of a regulation method based on the measured voltage drop and the current fed back into the grid. The respectively determined pre-ignition angle can then be optimized from cycle to cycle. As a control variable, the magnitude of the voltage drop in the switched-off (commutated) phase or the magnitude of the increase in voltage of the phase switched-on prematurely in accordance with the pre-ignition angle is taken into account at the instant of commutation. A predetermined maximum oscillation amplitude or predetermined maximum values for the voltage drop or the increase in voltage are taken into account as reference variables. The control loop may include a P controller, a PI controller or a PID controller in a manner known per se.

One possibility of obtaining a value for the current fed back into the grid consists in the form of a separate current measurement or by a value in this regard being read out from the drive control facility.

The above-cited object is also achieved by means of a drive control facility which operates according to the method as described here and below and toward that end includes means for performing the method. The invention is preferably implemented here in software or in both software and firmware. The invention is thus on the one hand also a computer program with program code instructions which can be executed by a computer and on the other hand a storage medium with a computer program of this type, in other words a computer program product with program code means, and exclusively also a drive control facility, with a processing facility in the form of or in the manner of a type of microprocessor and a storage device as means for implementing the method, wherein such a computer program is or can be loaded into the storage device as further means for implementing the method and its embodiments. A location which can be considered for such a computer program is for instance the control logic.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a drive control facility having an inverter on a high-voltage side and control logic for generating control signals for the inverter on a low-voltage side,

FIG. 2 shows a circuit of a conventional drive control facility according to FIG. 1,

FIG. 3 shows a space vector diagram according to the present invention,

FIG. 4 shows an oscillogram to illustrate oscillations resulting during the down-commutation of a phase of a grid-side inverter,

FIG. 5 shows an oscillogram according to FIG. 4, with a drive control facility operated according to the approach described here and

FIG. 6 shows a further oscillogram according to FIG. 4, with a drive control facility operated according to the approach described here.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

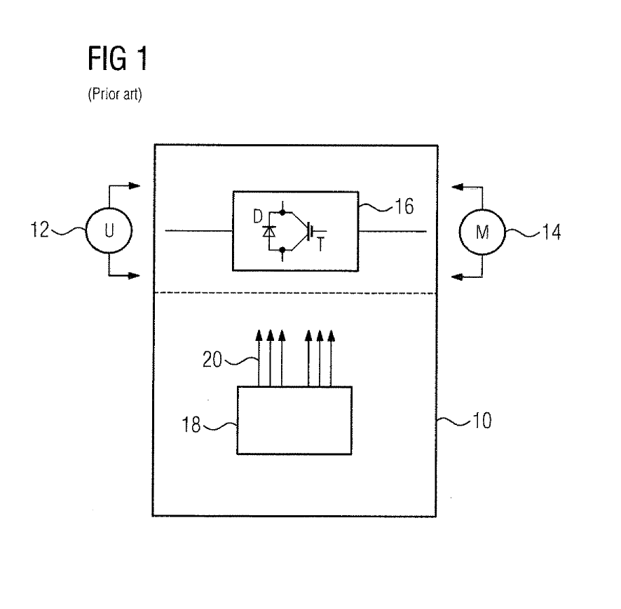

Turning now to the drawing, and in particular to FIG. 1, there is shown a schematically simplified diagram of a drive control facility 10 which is or can be connected to a voltage source 12 on the input side and to which a load 14 is or can be connected on the output side. The connected load is for example a speed-regulated electric motor 14. The drive control facility 10 comprises an inverter 16 having a per se known bridge circuit (shown only schematically), in particular in an embodiment as an IGBT B6 bridge, equipped with controllable semiconductor switches T and anti-parallel diodes D.

To regulate the speed of electric motors 14 as load for instance, but also in the instance of feedback and the generator operation of an electric motor 14, the inverter 16 generates, in a manner known per se from an intermediate DC voltage or an intermediate DC current, by suitably switching the semiconductor switch T, an output voltage with a variable frequency and voltage or a feedback voltage with the respective grid frequency.

For the approach shown here, only a grid or input-side inverter 16 is however relevant, so that the case is also included for instance whereby a DC machine is connected to the intermediate circuit or also without intermediate circuit directly to the inverter.

When reference is made below to an inverter 16, the grid-side inverter 16 is thus always understood to mean a drive control facility 10, which includes both an grid-side (input side) inverter 16 and also a load-side (output-side) inverter, and when reference is made to controllable semiconductor switches T, this is always understood to refer to the semiconductor switches T of the grid-side inverter 16.

Control logic 18 is provided for controlling the semiconductor switches T of the inverter 16. For each semiconductor switch T, the control logic 18 generates a control signal 20 which is transmitted to the respective semiconductor switch T. The inverter 16 is associated with a high-voltage side of the drive control facility 10. The control logic 18, on the other hand, belongs to a low-voltage side of the drive control device 10. The high voltage and low voltage side are separated in the representation by a dashed line and a potential separation is usually provided between the high voltage and low voltage side.

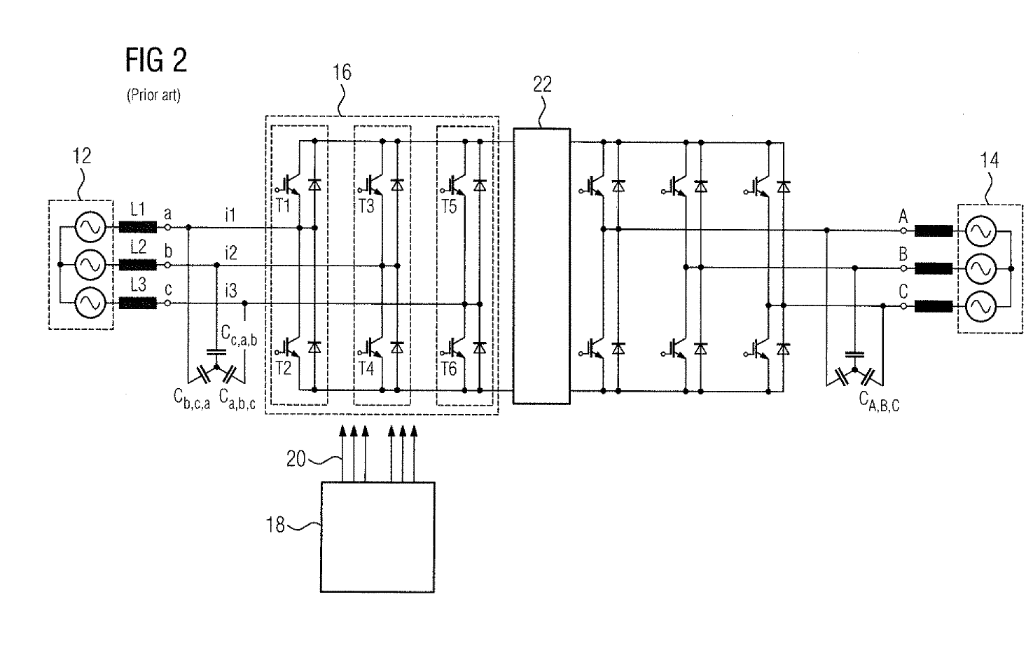

The representation in FIG. 2 shows a circuit known per se in further detail of a drive control facility 10 with the mentioned grid-side inverter 16 and the semiconductor switches T included therein, which, for clear referencing, are referred to with T1, T2, T3, T4, T5 and T6. Subsequent to the grid-side inverter 16, the circuit includes in a manner known per se an intermediate circuit 22, for instance a current intermediate circuit or a voltage intermediate circuit. This does not occur on the load-side inverter following the intermediate circuit 22 in the representation in FIG. 2, as already mentioned. The grid inductances L1, L2, L3 are shown on the input side and the current in each phase is referred to with i1, i2 and i3. The F3E capacitors connected at a star point are referred to with C_{a,b,c}, C_{b,c,a} and C_{c,a,b} and represent the capacitances between the points referred to with a, b and c. During generator operation of the electric motor 14, the direction of the currents i1, i2, i3 (feedback current) is in the direction of the source 12.

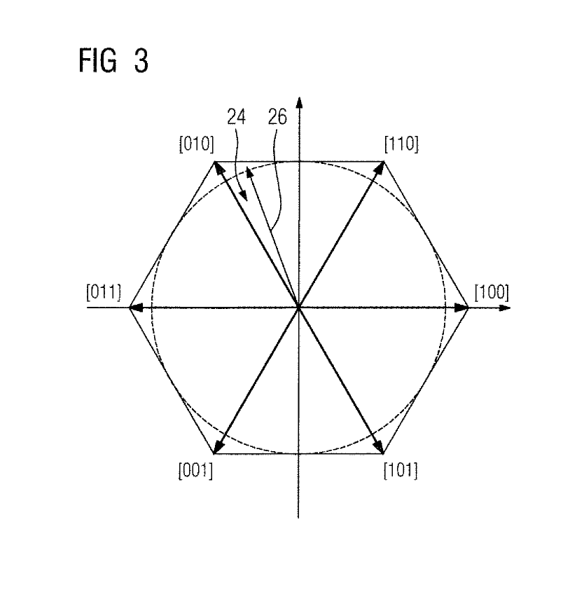

The representation in FIG. 3 shows a space vector diagram known per se with the usual six basic states. Each basic state is associated with a specific position of the semiconductor switches T1-T6 of the (grid-side) inverter 16. The state referred to here with “[1 1 0]” signifies for instance an activation of the semiconductor switches T1, T3 and T6 and a deactivation of the semiconductor switches T5, T2 and T4. During a commutation, in other words when the state “[0 1 0 1]” is reached, a deactivation of the semiconductor switch T1 (down commutation) takes place inter alia and overall this state indicates an activation of the semiconductor switches T3, T2 and T6 and a deactivation of the semiconductor switches T1, T5 and T4.

After switching off (deactivating) the semiconductor switch T1, the phase with the grid inductance L1 does not convey the current any further. The current i1, which is impressed until switching-off of the semiconductor switch T1 of the grid inductance L1 there, nevertheless results in a discharging of the F3E capacitor C_{b,c,a}. This discharge process continues until the current i1 previously impressed to the grid inductance L1 has decayed. This results in the previously observed voltage drop, which, when it reaches a specific variable, is unwelcome and even results in a faulty commutation.

With the changeover from the state referred to with “[1 1 0]” to the state referred to with “[0 1 0]”, a pre-ignition of the type described in the introduction relates accordingly, to the semiconductor switches referred to with T2. With a change in state at the instant of commutation, a deactivation of the first semiconductor switch T1 and a simultaneous activation of the second semiconductor switch T2 located in the same semiconductor bridges normally takes place. Within the scope of the pre-ignition, the activation of the second semiconductor switch T2 already takes place prior to the instant of commutation in other words at an instant at which the first semiconductor switch T1 is also still activated. The time instant at which this pre-ignition takes place is determined by the respective pre-ignition angle and the representation of the space vector diagram in FIG. 3 provides a good presentation of the pre-ignition angle 24. Accordingly, the pre-ignition angle 24 is the distance between the space vector 26 and the next instant of commutation. As soon as the region of the pre-ignition angle 24 is reached for a semiconductor switch T1-TG6, the control logic 18 generates a corresponding control signal 20 for these semiconductor switches T1-T6, so that this is already activated prior to the actual instant of commutation.

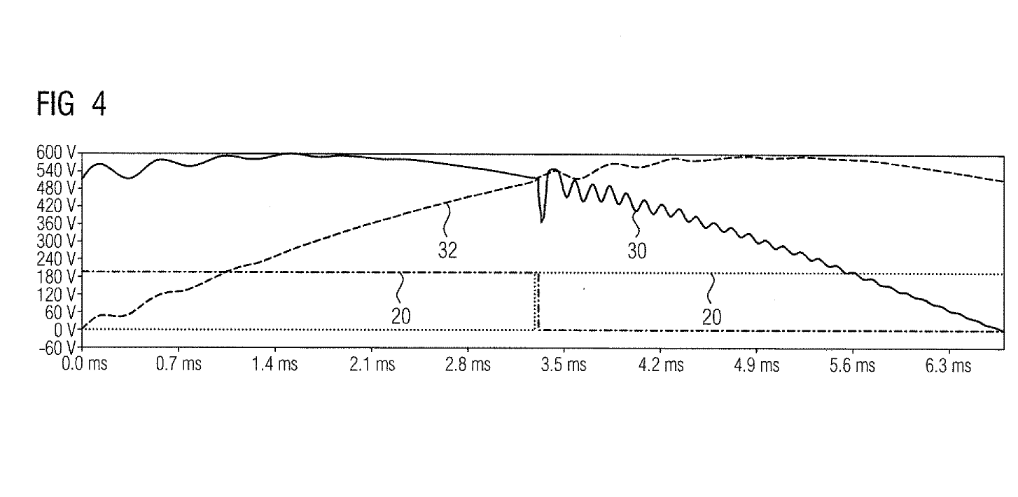

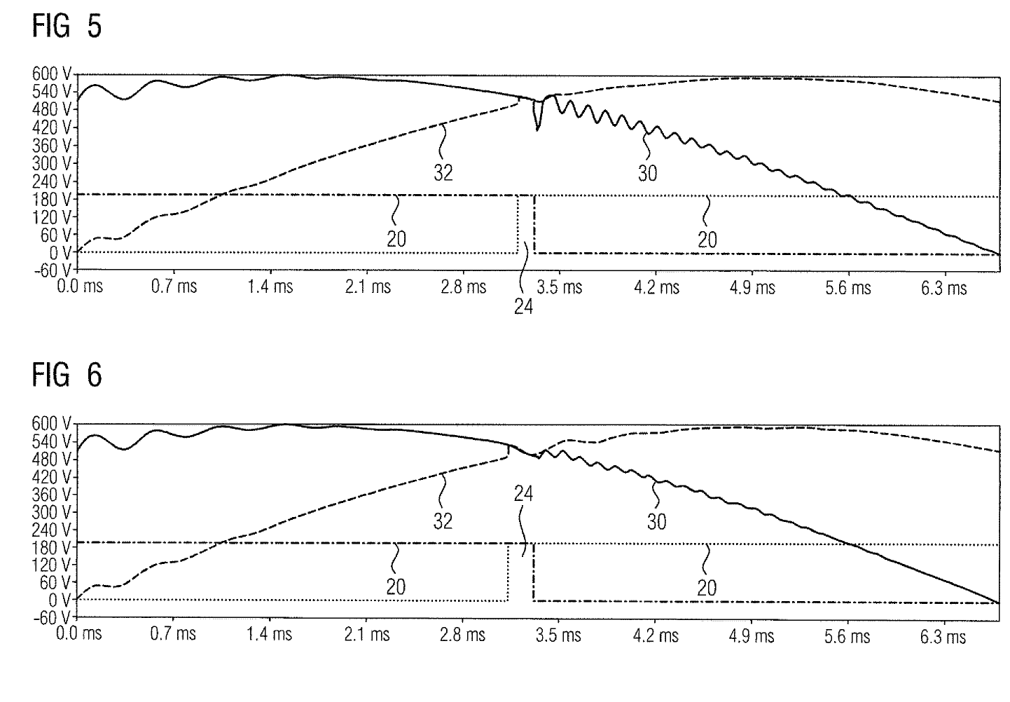

The representations in FIG. 4, FIG. 5 and FIG. 6 indicate a resulting oscillation when down-commutating a phase, namely an oscillation on account of an excessive voltage drop at the down-commutated phase (FIG. 4), a resulting oscillation when down-commutating with a small pre-ignition angle 24 (FIG. 5) and a resulting oscillation when down-commutating with a larger pre-ignition angle 24 (FIG. 6).

The voltage amplitude already reduced compared with a normal commutation (FIG. 4) with a small pre-ignition angle 24 (FIG. 5) and the oscillating amplitude significantly reduced with a larger pre-ignition angle 24 (FIG. 6) are identified. The pre-ignition angle 24 can be seen in the representations in FIG. 4, FIG. 5 and FIG. 6 also in the rectangular signal shown in the lower region.

The representation in FIG. 4 accordingly shows the oscillation resulting during a down-commutation of a phase at the normal instant of commutation, in other words according to the basic frequency control of the semiconductor switch. The graph 30 running downwards from top left to bottom right is the voltage of the down-commutated phase, in other words the phase which is switched off at the instant of commutation. The graph 32 running downwards from top left to bottom right is the voltage of the up-commutated phase, in other words the phase which is switched on at the instant of commutation. In the lower region of the representation in FIG. 4, the control signals 20 of the semiconductor switch affected by the observed commutation are shown, namely from left to right, a first control signal 20 firstly located at a high level for controlling the semiconductor switch which is deactivated at the instant of commutation and a second control signal 20 firstly located at the low level for controlling the semiconductor switch which is activated at the instant of commutation. It is apparent that the activation and deactivation of the two semiconductor switches affected by the observed instant of commutation (here in other words for instance the two semiconductor switches referred to with T1 and T2 in FIG. 2) takes place at the same time.

The representations in FIG. 5 indicate the same situation as in FIG. 4, however with a pre-ignition angle (FIG. 5) and a larger pre-ignition angle (FIG. 6).

The graph 30 running downwards from top left to bottom right is once again the voltage of the down-commutated phase, in other words the phase which is switched off at the instant of commutation. The graph 32 running downwards from top left to bottom right is the voltage of the up-commutated phase, in other words the phase which is switched on according to the respective pre-ignition angle 24 prior to the instant of commutation. In the lower region of the representations in FIG. 5 and FIG. 6, the control signals 20 of the semiconductor switch affected by the observed commutation are shown, namely from left to right, a first control signal 20 firstly located at a high level for controlling the semiconductor switch which is deactivated at the instant of commutation and a second, control signal 20 firstly located at the low level for controlling the semiconductor switch which is activated according to the respective pre-ignition angle 24 prior to the instant of commutation. The pre-ignition angle 24 is therefore the distance between the rising edge of the control signal 20 generated earlier and the falling edge of the control signal 20 generated at the normal instant of commutation.

It is apparent that the activation and deactivation of the two semiconductor switches affected by the observed instants of commutation (here in other words for instance the two semiconductor switches referred to with T1 and T2 in FIG. 2) takes place at different instants 24 on account of the respective pre-ignition angle 24. Furthermore, the reduced oscillation at the down-commutated phase (first graph 30) is shown, wherein the resulting oscillation is reduced again in the larger pre-ignition angle 24 shown in FIG. 6 also in comparison with the pre-ignition angle 24 shown in FIG. 5.

Individual aspects in the forefront of the description submitted here can therefore be briefly summarized as follows:

A method is specified for the regenerative operation of a drive control facility 10, which includes an inverter 16 with semiconductor switches T1-T6 which can be controlled by control signals 20, wherein a control logic 18 for each control signal 20 determines a control signal time instant and wherein the control of a semiconductor switch T1-T6 takes place in each instance by a control signal 20 generated by the control logic 18 at the respective control signal time instant, wherein the control of individual semiconductor switches T1-T6 takes place by means of a corresponding control signal 20 about a predetermined or predeterminable pre-ignition angle 24 prior to the determined control signal time instant.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for the regenerative operation of a drive control facility having an inverter comprising semiconductor switches controllable by control signals, the method comprising:
determining with a control logic a control signal time instant for each control signal, and
controlling individual semiconductor switches with a corresponding control signal generated by the control logic at a respective control signal time instant,
wherein the individual semiconductor switches are controlled by the corresponding control signal in accordance with a predetermined pre-ignition angle prior to the determined control signal time instant.

2. The method of claim 1, further comprising controlling, with the corresponding control signal generated in accordance with the pre-ignition angle, the semiconductor switches associated with a next phase to be commutated.

3. The method of claim 1, wherein the pre-ignition angle is dependent on a current fed back into a respective power grid or on a respective inductance of the power grid.

4. The method of claim 1, wherein the pre-ignition angle is dependent on a voltage drop at a respectively down-commutated phase.

5. The method of claim 4, further comprising measuring the voltage drop at the respectively down-commutated phase and generating the pre-ignition angle from the measured voltage drop.

6. The method of claim 3, further comprising measuring the voltage drop at the respectively down-commutated phase and generating the pre-ignition angle based on the current fed back into the respective power grid and the measured voltage drop.

7. The method of claim 6, wherein the pre-ignition angle results from a control method based on the measured voltage drop and the current fed back into the grid.

8. The method of claim 3, wherein a value for the current fed back into the network is generated based on a current measurement or based on the drive control facility.

9. A drive control facility having an inverter with semiconductor switches controllable by control signals from a control logic, the control logic configured to
determine control signal time instants for controlling the semiconductor switches with the control signals,
determine a pre-ignition angle so as to prematurely control individual semiconductor switches, and
control individual semiconductor switches with a corresponding control signal generated by the control logic based on the respective control signal time instants and the respective pre-ignition angle.

10. A computer program having program code embodied in a non-transitory computer-readable medium for enabling, when the computer program is executed by a control logic, regenerative operation of a drive control facility having an inverter comprising semiconductor switches controllable by control signals from the control logic, by
determining with the control logic a control signal time instant for each control signal, and
controlling individual semiconductor switches with a corresponding control signal generated by the control logic at a respective control signal time instant,
wherein the individual semiconductor switches are controlled by the corresponding control signal in accordance with a predetermined pre-ignition angle prior to the determined control signal time instant.

11. A drive control facility having an inverter with semiconductor switches controllable by control signals, comprising:
a processor generating control signals, and
a storage device into which a computer program is loaded, wherein the computer program, when executed by the processor during operation of the drive control facility, causes the processor to
determine control signal time instants for controlling the semiconductor switches with the control signals,
automatically determine a pre-ignition angle so as to prematurely control individual semiconductor switches, and
control individual semiconductor switches with a corresponding control signal generated by the control logic based on the respective control signal time instants and the respective determined pre-ignition angle.
